(19) United States
(12) Patent Application Publication
(10) Pub. No.: US 2023/0363424 A1
(43) Pub. Date: Nov. 16, 2023

(54) COMPOUNDS AND METHODS FOR ENHANCING SWEETNESS OF SWEETENERS

(71) Applicant: Conagen Inc., Bedford, MA (US)

(72) Inventors: Rui Zhou, Acton, MA (US); Suizhou Yang, North Chelmsford, MA (US)

(73) Assignee: Conagen Inc., Bedford, MA (US)

(21) Appl. No.: 18/347,759

(22) Filed: Jul. 6, 2023

Related U.S. Application Data
(63) Continuation of application No. PCT/US2022/011395, filed on Jan. 6, 2022.
(60) Provisional application No. 63/199,540, filed on Jan. 7, 2021.

(51) Int. Cl. A23L 2/60; A23L 27/00; A23L 29/00; A23L 33/125

(52) U.S. Cl. CPC A23L 2/60; A23L 27/88; A23L 29/035; A23L 33/125

(57) ABSTRACT

The present invention relates to a compound of Formula (I) and/or a physiologically acceptable salt, enantiomer, or solvate thereof. Said compound can be used in combination with one or more sweeteners to enhance their individual sweet taste or the overall sweet taste of a composition comprising said one or more sweeteners.

### RELATED APPLICATION

This application claims the benefit under 35 U.S.C. § 119(e) to U.S. Provisional Application No. 63/199,540, entitled “COMPOUNDS AND METHODS FOR ENHANCING SWEETNESS OF SWEETENERS”, filed on Jan. 7, 2021; the contents of which are incorporated herein by reference in their entirety.

### FIELD OF THE INVENTION

The field of the invention relates to compounds that can be used to enhance the sweet taste of sweeteners and methods of using such sweetness-enhancing compounds.

### BACKGROUND OF THE INVENTION

Consumers generally favor foods and beverages that taste sweet. However, it is also widely known that a high content of readily metabolizable carbohydrates causes a pronounced increase in the blood sugar level, leads to the formation of fatty deposits, and can lead to a plethora of health problems such as dental cavities, obesity, insulin resistance, diabetes and related secondary complications.

The oral detection of all sweeteners, including carbohydrates and noncaloric sweeteners, is performed by the heterodimeric type 1 taste receptor 2 (T1R2)/type 1 taste receptor 3 (T1R3) receptor. This receptor contains multiple binding sites, which explains the chemical diversity of sweet-tasting compounds. Sweet taste enhancers are small molecules that can increase sweetness perception by the modulation of T1R2/T1R3 receptor activity. These compounds act as positive allosteric modulators and boost taste sensation, allowing significant reduction in sweetener content while maintaining the same taste.

It is therefore desirable to develop substances which, in low concentrations, can effectively enhance the sweet taste of currently available sweeteners.

### SUMMARY OF THE INVENTION

The present invention addresses the problems described above by providing novel sweetness-enhancing compounds.

In a first aspect, provided herein is a composition comprising one or more sweeteners and a compound of Formula (I) and/or a physiologically acceptable salt, enantiomer, or solvate thereof:

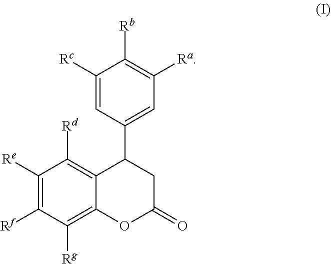

Each of R^{a}, R^{b}, and R^{c} independently can be H, OH, or a C₁₋₅ alkoxy group, provided that at least two of R^{a}, R^{b}, and R^{c} independently are OH or a C₁₋₅ alkoxy group; each of R^{d}, R^{e}, R^{f}, and R^{g} independently can be H, OH, or a C₁₋₅ alkyl group, provided that R^{d} is OH or a C₁₋₅ alkyl group; and wherein: R^{f} is H when (i) R^{a} is OCH₃ and R^{b} is OH or (ii) R^{a} is OH and R^{b} is OCH₃.

In some embodiments, R^{b} is OH and R^{a} is either OH or OCH₃. In some embodiments, R^{d} is either OH or CH₃.

In some embodiments, the composition comprises at least one of Compound (1), Compound (2), Compound (3), and/or a physiologically acceptable salt, enantiomer, or solvate thereof, wherein Compound (1) has the structure:

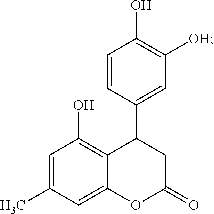 [SMILES: Cc1cc(O)c2c(c1)OC(=O)CC2c1ccc(O)c(O)c1]

Compound (2) has the structure:

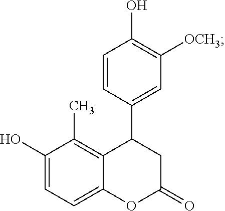 [SMILES: COc1cc(C2CC(=O)Oc3ccc(O)c(C)c32)ccc1O]

and
Compound (3) has the structure:

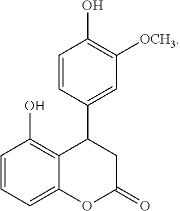 [SMILES: COc1cc(C2CC(=O)Oc3cccc(O)c32)ccc1O]

In some embodiments, the composition is an orally consumable composition and the compound of formula (I) is capable of enhancing the sweet taste of at least one of said sweeteners and/or the overall sweet taste of the composition.

In some embodiments, the one or more sweeteners are selected from the group consisting of a caloric sweetener, a non-caloric sweetener, an artificial sweetener, a natural high-potency sweetener, a sugar alcohol, a rare sugar, and a combination of any of the foregoing sweeteners.

In some embodiments, the caloric sweetener is selected from crystalline or liquid sucrose, fructose, glucose, dextrose, maltose, trehalose, fructo-oligosaccharides, glucose-fructose syrup; high fructose corn syrup, invert sugar, maple syrup, maple sugar, honey, brown sugar molasses, yacon syrup, cane molasses, sorghum syrup, and mixtures thereof.

In some embodiments, the artificial sweetener is saccharin, cyclamate, aspartame, neotame, advantame, acesulfame potassium, sucralose, or mixtures thereof. In some embodiments, the natural high-potency sweetener is a steviol glycoside, a glycosylated steviol glycoside, Luo Han Guo fruit extract, glycyrrhizin, or thaumatin. In some embodiments, the high-potency sweetener is rebaudioside A, rebaudioside B, rebaudioside C (dulcoside B), rebaudioside D, rebaudioside E, rebaudioside F, rebaudioside I, rebaudioside N, rebaudioside M, dulcoside A, rubusoside, stevioside, mogroside, or a mixture of any of the foregoing. In some embodiments, the sugar alcohol is mannitol, xylitol, sorbitol, erythritol, glycerol, threitol, arabitol, ribitol, maltitol, isomaltitol, ducitol, or lactitol. In some embodiments, the rare sugar is D-allose, D-allulose, L-ribose, D-tagatose, L-glucose, L-fucose, L-arabinose, D-turanose, D-leucrose, or mixtures thereof.

In some embodiments, the composition is a food product, a beverage, an oral care product, or a pharmaceutical composition.

In another aspect, there is provided a method of enhancing the sweet taste of a composition comprising one or more sweeteners, the method comprising adding to said composition an effective amount of a compound of Formula (I) and/or a physiologically acceptable salt, enantiomer, or solvate thereof:

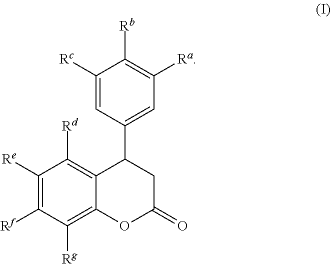

Each of R^{a}, R^{b}, and R^{c} independently can be H, OH, or a C₁₋₅ alkoxy group, provided that at least two of R^{a}, R^{b}, and R^{c} independently are OH or a C₁₋₅ alkoxy group; each of R^{d}, R^{e}, R^{f}, and R^{g} independently can be H, OH, or a C₁₋₅ alkyl group, provided that R^{d} is OH or a C₁₋₅ alkyl group; and wherein: R^{f} is H when (i) R^{a} is OCH₃ and R^{b} is OH or (ii) R^{a} is OH and R^{b} is OCH₃.

In some embodiments, R^{b} is OH and R^{a} is either OH or OCH₃. In some embodiments, R^{d} is either OH or CH₃.

In some embodiments, the compound of formula (I) is Compound (1), Compound (2), or Compound (3), wherein:
Compound (1) has the structure:

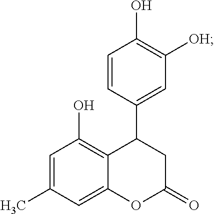 [SMILES: Cc1cc(O)c2c(c1)OC(=O)CC2c1ccc(O)c(O)c1]

Compound (2) has the structure:

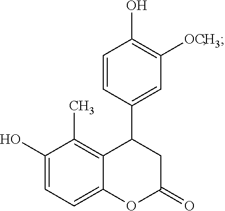 [SMILES: COc1cc(C2CC(=O)Oc3ccc(O)c(C)c32)ccc1O]

and
Compound (3) has the structure:

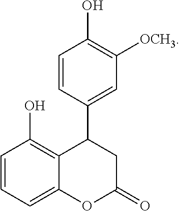 [SMILES: COc1cc(C2CC(=O)Oc3cccc(O)c32)ccc1O]

In some embodiments, said composition is an orally consumable composition. In some embodiments, the composition is a food product, a beverage, an oral care product, or a pharmaceutical composition.

In some embodiments, the one or more sweeteners are selected from the group consisting of a caloric sweetener, a non-caloric sweetener, an artificial sweetener, a natural high-potency sweetener, a sugar alcohol, a rare sugar, and a combination of any of the foregoing sweeteners.

In some embodiments, the caloric sweetener is the caloric sweetener is selected from crystalline or liquid sucrose, fructose, glucose, dextrose, maltose, trehalose, fructo-oligosaccharides, glucose-fructose syrup; high fructose corn syrup, invert sugar, maple syrup, maple sugar, honey, brown sugar molasses, yacon syrup, cane molasses, sorghum syrup, and mixtures thereof.

In some embodiments, the artificial sweetener is saccharin, cyclamate, aspartame, neotame, advantame, acesulfame potassium, sucralose, or mixtures thereof. In some embodiments, the natural high-potency sweetener is a steviol glycoside, a glycosylated steviol glycoside, Luo Han Guo fruit extract, glycyrrhizin, or thaumatin. In some embodiments, the high-potency sweetener is rebaudioside A, rebaudioside B, rebaudioside C (dulcoside B), rebaudioside D, rebaudioside E, rebaudioside F, rebaudioside I, rebaudioside N, rebaudioside M, dulcoside A, rubusoside, stevioside, mogroside, or a mixture of any of the foregoing. In some embodiments, the sugar alcohol is mannitol, xylitol, sorbitol, erythritol, glycerol, threitol, arabitol, ribitol, maltitol, isomaltitol, ducitol, or lactitol. In some embodiments, the rare sugar is D-allose, D-allulose, L-ribose, D-tagatose, L-glucose, L-fucose, L-arabinose, D-turanose, D-leucrose, or mixtures thereof.

In yet another aspect, the present teachings provide a compound of Formula (I) and/or a physiologically acceptable salt, enantiomer, or solvate thereof:

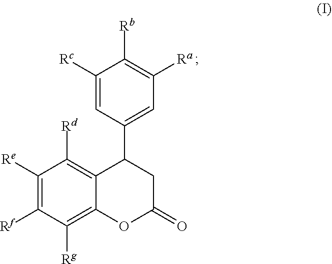

wherein each of R^{a}, R^{b}, and R^{c} independently are H, OH, or a C₁₋₅ alkoxy group, provided that at least two of R^{a}, R^{b}, and R^{c} independently are OH or a C₁₋₅ alkoxy group; each of R^{d}, R^{e}, R^{f}, and R^{g} independently are H, OH, or a C₁₋₅ alkyl group, provided that R^{d} is OH or a C₁₋₅ alkyl group; and wherein R^{f} is H when (i) R^{a} is OCH₃ and R^{b} is OH or (ii) R^{a} is OH and R^{b} is OCH₃. The compound of Formula (I) can be added to a composition comprising one or more sweeteners, such that the perception of sweetness intensity of at least one of said sweeteners or the overall sweet taste of the composition is enhanced.

While the disclosure is susceptible to various modifications and alternative forms, specific embodiments thereof are shown by way of example in the drawing and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure as defined by the appended claims.

Other features and advantages of this invention will become apparent in the following detailed description of preferred embodiments of this invention, taken with reference to the accompanying drawings if present.

### BRIEF DESCRIPTION OF THE DRAWINGS

FIG. 1 provides an NMR spectrum of Compound (1) as prepared according to Example 1.

FIG. 2 provides an NMR spectrum of Compound (2) as prepared according to Example 2.

FIG. 3 provides an NMR spectrum of Compound (3) as prepared according to Example 3.

### DEFINITIONS

Various examples and embodiments of the inventive subject matter disclosed here are possible and will be apparent to the person of ordinary skill in the art, given the benefit of this disclosure. In this disclosure reference to “some embodiments,” “certain embodiments,” “certain exemplary embodiments” and similar phrases each means that those embodiments are non-limiting examples of the inventive subject matter, and there are alternative embodiments which are not excluded.

Unless otherwise indicated or unless otherwise clear from the context in which it is described, alternative and optional elements or features in any of the disclosed embodiments and examples are interchangeable with each other. That is, an element described in one embodiment or example should be understood to be interchangeable or substitutable for one or more corresponding but different elements in another described example or embodiment and, likewise, an optional feature of one embodiment or example may optionally also be used in other embodiments and examples. More generally, the elements and features of any disclosed example or embodiment should be understood to be disclosed generally for use with other aspects and other examples and embodiments. A reference to a component or ingredient being operative or configured to perform one or more specified functions, tasks and/or operations or the like, is intended to mean that it can perform such function(s), task(s), and/or operation(s) in at least certain embodiments, and may well be able to perform also one or more other functions, tasks, and/or operations.

The articles “a,” “an,” and “the” are used herein to refer to one or to more than one (i.e., to at least one) of the grammatical object of the article. By way of example, “an element” means one element or more than one element.

The word “comprising” is used in a manner consistent with its open-ended meaning, that is, to mean that a given product or process can optionally also have additional features or elements beyond those expressly described.

The terms “beverage concentrate,” “concentrate,” and “syrup” are used interchangeably throughout this disclosure and refer to an aqueous sweetener composition suitable for use in beverage preparation. Exemplary embodiments are described elsewhere in this disclosure.

As used herein, the term “Brix” means the sugar content of an aqueous solution (w/w). By way of example only, a solution that is 1-degree Brix contains 1 g of sucrose in 100 grams of solution, while a solution that is 5 degrees Brix contains 5 g sucrose in 100 g solution.

As used herein, the phrase “edible consumables” means a food, beverage, or an ingredient of a food or beverage suitable for human or animal consumption.

The term “sweetness recognition threshold concentration,” as generally used herein, is the lowest known concentration of a given sweetener or combination of sweeteners that is perceivable by the human sense of taste, typically around about 1.5% sucrose equivalence.

As used herein, “taste” refers to a combination of sweetness perception, temporal effects of sweetness perception (i.e., on-set and duration), off-tastes (e.g., bitterness and metallic taste), residual perception (aftertaste), and tactile perception (e.g., body and thickness).

As used herein, a “full-calorie” beverage formulation is one fully sweetened with a caloric sweetener.

The term “caloric sweetener” refers generally to sweeteners which provide significant caloric content in typical usage amounts, e.g., more than about 5 calories per 8 oz. serving of a beverage.

As used herein, the term “non-caloric sweetener” refers to all sweeteners other than caloric sweeteners.

As used herein, a “natural high-potency sweetener” means a natural sweetener which is at least twice as sweet as sugar, i.e., a sweetener which on a weight basis requires no more than half the weight of traditional sugar (sucrose) to achieve an equivalent sweetness. For example, a natural high-potency sweetener may require less than one-half the weight of sugar to achieve an equivalent sweetness in a beverage sweetened to a level of 10 degrees Brix with sugar. Natural high-potency sweeteners include both caloric and non-caloric sweeteners.

As used herein, the phrase “weight percent” refers to a weight percent calculated based on the total weight of a given composition or formulation. By way of example only, a sweetener composition comprising 5 g of a sweetness enhancer as described herein and 95 g of a caloric sweetener, would comprise 5 weight percent of the sweetness enhancer and 95 weight percent of the caloric sweetener.

As used in this disclosure, unless otherwise specified, the term “added,” “combined,” and terms of similar character mean that the multiple ingredients or components referred to (e.g., one or more sweeteners, sweetness enhancers, etc.) are combined in any manner and in any order, with or without stirring.

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the preferred materials and methods are described below.

### DETAILED DESCRIPTION

After testing a large number of molecules, it has been surprisingly discovered that compounds of Formula (I) below unexpectedly act as sweetness enhancers. Accordingly, the present disclosure provides methods and compositions for enhancing the sweetness of one or more sweeteners using a compound of Formula (I), or a physiologically acceptable salt, enantiomer, or solvate thereof, as sweetness enhancer:

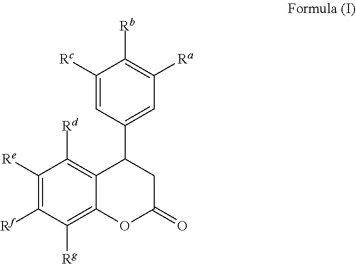

In Formula (I), each of moieties R^{a}, R^{b}, and R^{c} is independently H, OH, or an alkoxy group comprising 1 to 5 carbon atoms (“a C₁₋₅ alkoxy group”), provided that at least two of R^{a}, R^{b}, and R^{c} are independently OH or a C₁₋₅ alkoxy group. Each of moieties R^{d}, R^{e}, R^{f}, and R^{g} is independently H, OH, or an alkyl group comprising 1 to 5 carbon atoms (a “C₁₋₅ alkyl group”), provided that R^{d} is OH or a C₁₋₅ alkyl group. In addition, R^{f} is H when (i) R^{a} is —OCH₃ and R^{b} is OH or (ii) R^{a} is OH and R^{b} is OCH₃. The C₁₋₅ alkyl group and the C₁₋₅ alkoxy group independently may be linear or branched, and each may include 1, 2, 3, 4, or 5 carbon atoms. The range 1-5 should be understood to encompass ranges of 1-4, 1-3, and 1-2. In some embodiments, R^{b} is OH and R^{a} is either OH or OCH₃. In further embodiments, R^{d} may be either OH or CH₃. It is also to be understood that the compounds of Formula (I) include their isomers and mixtures thereof, for instance the isomers of Formula (Ia) and Formula (Ib):

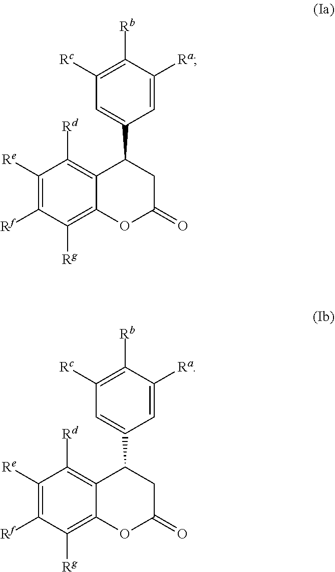

In some embodiments, the compound of Formula (I) can be Compound (1), Compound (2), or Compound (3):

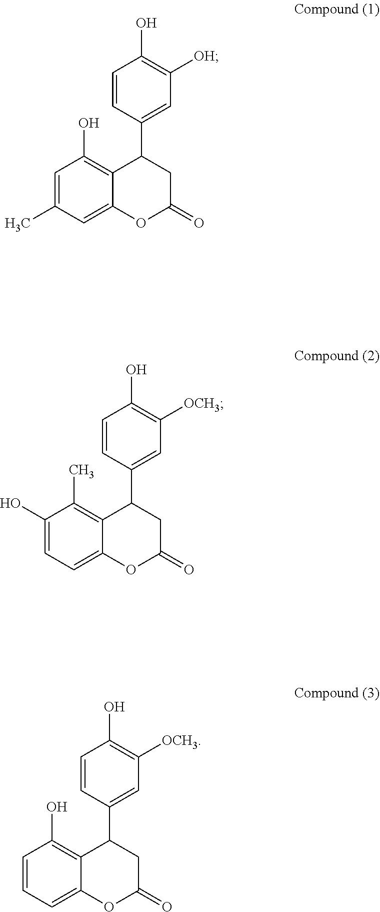 [SMILES: Cc1cc(O)c2c(c1)OC(=O)CC2c1ccc(O)c(O)c1 ; COc1cc(C2CC(=O)Oc3ccc(O)c(C)c32)ccc1O ; COc1cc(C2CC(=O)Oc3cccc(O)c32)ccc1O]

A sweetener composition according to the present disclosure can include at least one of Compound (1), Compound (2), Compound (3), and/or their respective physiologically acceptable salts, enantiomers, or solvates, inclusive of isomers such as: Compound (1A), Compound (1B), Compound (2A), Compound (2B), Compound (3A), and Compound (3B):

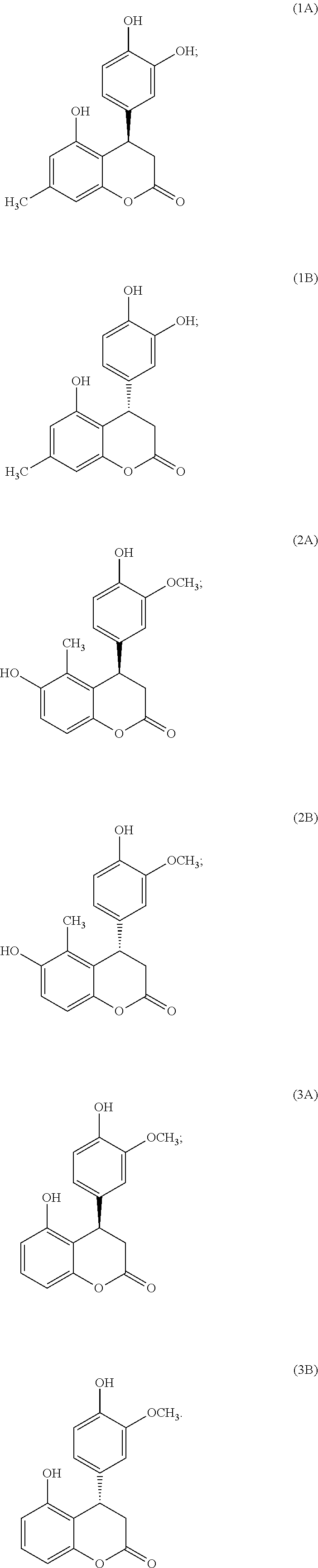 [SMILES: Cc1cc(O)c2c(c1)OC(=O)C[C@@H]2c1ccc(O)c(O)c1 ; Cc1cc(O)c2c(c1)OC(=O)C[C@H]2c1ccc(O)c(O)c1 ; COc1cc([C@H]2CC(=O)Oc3ccc(O)c(C)c32)ccc1O ; COc1cc([C@@H]2CC(=O)Oc3ccc(O)c(C)c32)ccc1O ; COc1cc([C@H]2CC(=O)Oc3cccc(O)c32)ccc1O ; COc1cc([C@@H]2CC(=O)Oc3cccc(O)c32)ccc1O]

Compounds of Formula (I) can enhance the sweetness of caloric and non-caloric sweeteners and allow manufacturers to reduce the amount of sweetener used in a given food or beverage.

In certain embodiments, one or more compounds of Formula (I) may be combined with one or more sweeteners to form a sweetener composition. In certain embodiments, this blend can be a granular or powdered composition suitable for use as a tabletop sweetener or for addition to food or beverage products. Alternatively, the sweetener composition may be an aqueous solution. The aqueous solution may be a liquid tabletop sweetener or a sweetener solution that is then added to other ingredients to form a beverage or beverage syrup (concentrate). In certain embodiments, the aqueous solution may be a syrup. Alternatively, the compound of Formula (I) can be added directly to food or beverage products already containing a sweetener.

In certain embodiments, the sweetener composition may comprise from about 0.0005 weight percent to about 75 weight percent of one or more compounds of Formula (I). In other embodiments, the sweetener composition can comprise from about 0.0005 weight percent to about 65 weight percent; from about 0.0005 weight percent to about 55 weight percent; from about 0.0005 weight percent to about 45 weight percent; from about 0.0005 weight percent to about 35 weight percent; from about 0.0005 weight percent to about 25 weight percent; from about 0.0005 weight percent to about 20 weight percent; from about 0.0005 weight percent to about 25 weight percent; from about 0.0005 weight percent to about 15 weight percent; from about 0.001 to about 10 weight percent; from about 0.001 to about 5 weight percent, from about 0.001 to about 1 weight percent; or from about 0.001 weight percent to about 0.5 weight percent of the one or more compounds of Formula (I).

In embodiments where the sweetener composition is an aqueous solution, such as a beverage suitable for use without further dilution, the weight percentage of the one or more compounds of Formula (I) in the composition may correspond to a concentration of less than about 1000 ppm, such as, for example, from about 5 ppm to about 800 ppm, from about 50 ppm to about 600 ppm, or from about 100 ppm to about 400 ppm.

In certain embodiments, less than about 1000 ppm of one or more compounds of Formula (I) can be used to enhance the sweetness of a caloric and/or non-caloric sweetener. At this concentration, the quantity of sweetener used in a given food or beverage can be reduced by about 5 to about 40%, and in certain embodiments, from about 10 to about 25%, or about 25%, in comparison to the food or beverage not including phloroglucinol. At less than about 1000 ppm, a compound of Formula (I) does not sweeten by itself, but is suitable to increase sweetness perception by, in certain embodiments, from about 0.5 to about 3 degrees Brix. Thus, in certain embodiments, the sweetener composition described herein can increase sweetness by about 0.5 Brix, about 1 Brix, about 1.5 Brix, about 2 Brix, about 2.5 Brix, or about 3 Brix.

In certain embodiments, the sweetener is a caloric sweetener. In certain embodiments, the compound of Formula (I) and the caloric sweetener are present in a weight ratio of from about 1:150 to about 1:50. In certain embodiments, the sweetener is a non-caloric sweetener. In certain embodiments, the sweetener is a natural non-caloric sweetener selected from the group consisting of rebaudioside A, rebaudioside B, rebaudioside C, rebaudioside D, rebaudioside M, mogrosides, trilobatin, and combinations thereof. In certain embodiments, the compound of Formula (I) and non-caloric sweetener are present in a weight ratio of from about 1.2:1 to about 1:1.2. In certain embodiments, the sweetener composition is a tabletop sweetener.

The sweetness enhancers described in this disclosure are suitable for reducing the amounts of caloric and/or non-caloric sweeteners in orally consumable items while maintaining the desired sweet taste. Compositions comprising the compound of Formula (I) and a sweetener may be orally consumable sweetener compositions finding use in, for example, foods, beverages, syrups, oral pharmaceuticals, and other formulations including the sweetener composition. In certain embodiments, the sweetener composition may be in a dry form, e.g., a solid or powder. However, in other embodiments, the sweetener composition may be in a gel or liquid form. In certain embodiments, the sweetener composition can further include a salt.

The orally consumable composition may be a food product, a functional food, a beverage product, a pharmaceutical, a dietary supplement, a nutraceutical, a dental hygiene composition, a food grade gel composition, a cosmetic product, and a flavoring product.

Non-exhaustive examples of food products can include cereal products, rice products, tapioca products, sago products, baker's products, biscuits, bread, breakfast cereal, cereal bar, energy bars/nutritional bars, granola, cakes, cookies, crackers, donuts, muffins, pastries, chocolates, ices, honey products, treacle products, yeast products, baking-powder, salt products, spice products, savory products, mustard products, vinegar products, sauces (condiments), tobacco products, cigars, cigarettes, processed foods, cooked fruits, vegetable products, meat, meat products, jellies, jams, gelatins, fruit sauces, egg products, milk products, dairy products, yoghurts, cheese products, butter, butter substitute products, milk substitute products, soy products, edible oils, fat products, food extracts, plant extracts, meat extracts, and condiments. A functional food can be any of the foregoing food products with dietary supplements or nutraceuticals added.

Non-exhaustive examples of beverage products can include coffee, tea, fermented tea, a dairy beverage, a plant-based milk beverage, an alcoholic beverage, flavored water, vitamin water, fruit juice, and an energy drink.

A dietary supplement include compounds intended to supplement the diet and provide nutrients, such as vitamins, minerals, fiber, fatty acids, amino acids, etc. that may be missing or may not be consumed in sufficient quantities in a diet. Any suitable dietary supplement known in the art may be used. Examples of suitable dietary supplements can be, for example, nutrients, vitamins, minerals, fiber, fatty acids, herbs, botanicals, amino acids, and metabolites.

A nutraceutical can include any food or part of a food that may provide medicinal or health benefits, including the prevention and/or treatment of disease or disorder (e.g., fatigue, insomnia, effects of aging, memory loss, mood disorders, cardiovascular disease and high levels of cholesterol in the blood, diabetes, osteoporosis, inflammation, autoimmune disorders, etc.). Any suitable nutraceutical known in the art may be used. In some embodiments, nutraceuticals can be used as supplements to food and beverages and as pharmaceutical formulations for enteral or parenteral applications which may be solid formulations, such as capsules or tablets, or liquid formulations, such as solutions or suspensions.

A gel can refer to any colloidal systems in which a network of particles spans the volume of a liquid medium. Although gels mainly are composed of liquids, and thus exhibit densities similar to liquids, gels have the structural coherence of solids due to the network of particles that spans the liquid medium. For this reason, gels generally appear to be solid, jelly-like materials. Gels can be used in a number of applications. For example, gels can be used in foods, paints, and adhesives. Gels that can be eaten are referred to as “edible gel compositions.” Edible gel compositions typically are eaten as snacks, as desserts, as a part of staple foods, or along with staple foods. Examples of suitable edible gel compositions can be, for example, gel desserts, puddings, jams, jellies, pastes, trifles, aspics, marshmallows, gummy candies, and the like. In some embodiments, edible gel mixes generally are powdered or granular solids to which a fluid may be added to form an edible gel composition. Examples of suitable fluids can be, for example, water, dairy fluids, dairy analogue fluids, juices, alcohol, alcoholic beverages, and combinations thereof. Examples of suitable dairy fluids can be, for example, milk, cultured milk, cream, fluid whey, and mixtures thereof. Examples of suitable dairy analogue fluids can be, for example, soy milk and non-dairy coffee whitener.

A composition including one of the present sweetness enhancers may include various pharmaceuticals known in the art. In certain embodiments, a pharmaceutical composition of the present disclosure can contain from about 5 ppm to about 200 ppm of the present sweetness enhancer, and one or more pharmaceutically acceptable excipients. In some embodiments, pharmaceutical compositions of the present disclosure can be used to formulate pharmaceutical drugs containing one or more active agents that exert a biological effect. Accordingly, in some embodiments, pharmaceutical compositions of the present disclosure can contain an effective amount of one or more active agents that exert a biological effect. Suitable active agents are well known in the art (e.g., The Physician's Desk Reference). Such compositions can be prepared according to procedures well known in the art, for example, as described in Remington's Pharmaceutical Sciences, Mack Publishing Co., Easton, Pa., USA.

The present sweetness enhancers also may be used with any suitable dental and oral hygiene compositions known in the art. Examples of suitable dental and oral hygiene compositions may be, for example, toothpastes, tooth polishes, dental floss, mouthwashes, mouthrinses, dentrifices, mouth sprays, mouth refreshers, plaque rinses, dental pain relievers, and the like.

In some embodiments, the sweetener composition can include one or more supplemental sweetness enhancers in addition to those of Formula (I).

In certain embodiments, the consumable composition can include a flavor agent. The flavor agent can be chosen from synthetic flavor oils and flavoring aromatics, and/or oils, oleo resins and extracts derived from plants, leaves, flowers, fruits and so forth, and combinations thereof. Representative flavor oils include cinnamon oil, peppermint oil, clove oil, bay oil, eucalyptus oil, thyme oil, cedar leaf oil, oil of nutmeg, oil of sage, and oil of bitter almonds. Also useful are artificial, natural or synthetic fruit flavors such as vanilla, and citrus oil, including lemon, orange, grape, lime and grapefruit and fruit essences including apple, pear, peach, strawberry, raspberry, cherry, plum, pineapple, apricot and so forth. Any of these flavor agents may be used individually or in admixture. Commonly used flavors include mints such as peppermint, menthol, vanilla, cinnamon derivatives, and various fruit flavors, whether employed individually or in admixture. Flavor agents such as aldehydes and esters including cinnamyl acetate, cinnamaldehyde, citral, diethyllacetal, dihydrocarvyl acetate, eugenyl formate, p-methylanisole, and so forth may also be used. Generally, any flavoring or food additive such as those described in Chemicals Used in Food Processing, pub 1274 by the National Academy of Sciences, pages 63-258 may be used as flavor agents in the invention.

Typically, the consumable compositions of the present invention may be prepared utilizing techniques well known to those of ordinary skill in the art. As such, the consumable compositions of the present invention may include various other components which are customarily used in the preparation of such consumable compositions, and which would be known to those of skill in the art.

The present consumable composition can be formulated into various forms including tablets, chews, edible films, gels, solutions, suspensions, emulsions, and so forth. For example, when the consumable composition of the present invention is in the form of a liquid pharmaceutical composition, or even a toothpaste, dental cream or gel, such a form typically includes a liquid carrier material for the bitter tastant and the bitter blocker. The carrier material may comprise water, typically in an amount of from about 10% to about 90% by weight of the consumable composition. Carrier materials include, but are not limited to, polyethylene glycol (PEG), propylene glycol (PG), glycerin or mixtures thereof. In addition, the consumable composition may include humectants, such as, for example, sorbitol, glycerin, and polyalcohols. Particularly advantageous liquid ingredients comprise mixtures of water with polyethylene glycol, propylene glycol, or glycerin and sorbitol. A gelling agent (thickening agent) including natural or synthetic gums, such as sodium carboxymethylcellulose, hydroxyethyl cellulose, methyl cellulose and the like, may also be used, typically in the range of about 0.15% to about 1.30% by weight of the consumable composition. In a toothpaste, dental cream or gel, the liquids and solids are proportioned to form a creamy or gelled mass which is extrudable from a pressurized container or from a collapsible tube.

The consumable composition of the present invention may also include a thickening agent or binder. For example, the thickening agent or binder may be selected from the group consisting of finely particulate gel silicas and nonionic hydrocolloids, such as carboxymethyl cellulose, sodium hydroxymethyl cellulose, hydroxyethylcellulose, hydroxypropyl guar, hydroxyethyl starch, polyvinyl pyrrolidone, vegetable gums, such as tragacanth, agar, carrageenans, gum arabic, xanthan gum, guar gum, locust bean gum, carboxyvinyl polymers, fumed silica, silica clays and the like, and combinations thereof. For example, a preferred thickening agent for use in toothpastes is carrageenan available under the trade names GELCARIN® and VISCARIN® from FMC Biopolymers, Philadelphia, Pa., U.S.A. Other thickening agents or binders are polyvinyl pyrrolidone available from Noveon, Inc. Cleveland, Ohio, U.S.A. under the trademark CARBOPOL®, fumed silica under the trademark CAB-O-SIL® available from Cabot Corporation, Boston, Mass., U.S.A., and silica clays available from Laporte Industries, Ltd., London, U.K. under the trademark LAPOINTE®. The thickening agent or binder may be used with or without a carrier, such as glycerol, polyethylene glycol (e.g., PEG-400), or combinations thereof; however, when a carrier is used, preferably up to about 5% thickening agent or binder, more preferably from about 0.1% to about 1.0%, is combined with preferably from about 95.0% to about 99.9% carrier, more preferably from about 99.0% to about 99.9%, based on the total weight of the thickening agent/carrier combination. Furthermore, when the thickening agent or binder is a hydrated silica and it is used with a carrier, preferably from about 5% to about 10% thickening agent or binder is combined with preferably from about 90% to about 95% carrier, based on the total weight of the thickening agent/carrier combination.

The consumable composition of the present invention may also contain coloring agents or colorants, such as colors, dyes, pigments and particulate substances, in amounts effective to produce the desired color of the particular consumable composition. The coloring agents (colorants) useful in the invention include the pigments such as titanium dioxide, which may be incorporated in amounts of up to about 2% by weight of the consumable composition, and preferably less than about 1% by weight. Colorants may also include natural food colors and dyes suitable for food, drug and cosmetic applications. For example, food grade and/or pharmaceutically acceptable coloring agents, dyes, or colorants, as would be understood to one skilled in the art, include FD&C colorants such as primary FD&C Blue No. 1, FD&C Blue No. 2, FD&C Green No. 3, FD&C Yellow No. 5, FD&C Yellow No. 6, FD&C Red No. 3, FD&C Red No. 33 and FD&C Red No. 40 and lakes FD&C Blue No. 1, FD&C Blue No. 2, FD&C Yellow No. 5, FD&C Yellow No. 6, FD&C Red No. 2, FD&C Red No. 3, FD&C Red No. 33, FD&C Red No. 40 and combinations thereof.

In addition, the consumable composition of the invention may also include a surfactant, such as sodium lauryl sulfate (SLS) (preferably in an amount of from about 1% to about 2% of the total weight of the oral composition), and/or a preservative, such as sodium benzoate (preferably in an amount of about 0.2% of the total weight of the oral composition).

Sweeteners

As set forth in this disclosure, the sweetness enhancer of Formula (I) can be combined with one or more caloric and/or non-caloric sweeteners to form a sweetener composition. Sweeteners and combinations of sweeteners for use in the sweetener composition can be selected for any of their nutritional characteristics, taste profile, mouthfeel, or other organoleptic properties.

The sweeteners included in the formulations of the compositions and products disclosed here are edible consumables. The sweetener can be a caloric or non-caloric, natural or artificial sweetener, or a combination of such sweeteners, so long as the sweetener or combination of sweeteners provides a taste which is perceived as sweet by the sense of taste. The perception of flavoring agents and sweetening agents can depend to some extent on the interrelation of elements. Flavor and sweetness can also be perceived separately, i.e., flavor and sweetness perception can be both dependent upon each other and independent of each other. For example, when a large amount of a flavoring agent is used, a small amount of a sweetening agent can be readily perceptible and vice versa. Thus, the oral and olfactory interaction between a flavoring agent and a sweetening agent can involve the interrelationship of elements.

When used to sweeten, the sweetener or combination of sweeteners in the sweetener composition is present in an amount above the sweeteners' sweetness recognition threshold concentration.

Exemplary natural caloric sweeteners suitable for use in the sweetener composition include crystalline or liquid sucrose, fructose, glucose, dextrose, maltose, trehalose, fructo-oligosaccharides, glucose-fructose syrup from natural sources such as apple, chicory, and honey; high fructose corn syrup, invert sugar, maple syrup, maple sugar, honey, brown sugar molasses, yacon syrup, cane molasses, such as first molasses, second molasses, blackstrap molasses, and sugar beet molasses; sorghum syrup, and mixtures thereof.

Other sweeteners suitable for use in the sweetener composition include, but are not limited to, sugar alcohols such as erythritol, sorbitol, mannitol, xylitol, lactitol, isomaltitol, maltitol, tagatose, trehalose, galactose, rhamnose, cyclodextrin, ribulose, threose, arabinose, xylose, lyxose, allose, altrose, mannose, idose, lactose, maltose, isotrehalose, neotrehalose, palatinose or isomaltulose, erythrose, deoxyribose, gulose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhamnose, ribose, and mixtures thereof.

Other sweeteners suitable for use in the sweetener composition include rare sugars such as D-allose, D-psicose (also known as D-allulose), L-ribose, D-tagatose, L-glucose, L-fucose, L-arabinose, D-turanose, D-leucrose, and mixtures thereof.

Exemplary artificial sweeteners suitable for use in the sweetener composition include, but are not limited to, saccharin, cyclamate, aspartame, neotame, advantame, acesulfame potassium, sucralose, and mixtures thereof.

Exemplary natural non-caloric high-potency sweeteners suitable for use in the sweetener composition disclosed here include steviol glycosides (e.g., stevioside, steviolbioside, rebaudioside A, rebaudioside B, rebaudioside C, rebaudioside D, rebaudioside E, rebaudioside F, rebaudioside H, rebaudioside I, rebaudioside N, rebaudioside K, rebaudioside J, rebaudioside 0, rebaudioside M, dulcoside A, rubusoside, iso-steviol glycosides such as iso-rebaudioside A, and mixtures thereof), Lo Han Guo powder, neohesperidin dihydrochalcone, trilobatin, glycyrrhizin, phyllodulcin, hernandulcin, osladin, polypodoside A, baiyunoside, pterocaryoside, thaumatin, monellin, monatin, mabinlins I and II, and mixtures thereof.

In other embodiments, Lo Han Guo juice concentrate can be used as a caloric and natural high-potency sweetener in the sweetener composition.

In certain embodiments, combinations of one or more natural caloric sweeteners, one or more artificial sweeteners, and/or one or more natural non-caloric high-potency sweeteners can be used. The foregoing notwithstanding, it should also be recognized that any of the identified sweeteners can, either in addition or instead of, act as supplemental sweetness enhancers, masking agents, or the like, when used in amounts below its (or their) sweetness perception threshold.

Supplemental Sweetness Enhancers

Although one or more compounds of Formula (I) may be used as a sweetness enhancer in the complete or substantial absence of further sweetness enhancers, in certain embodiments, the sweetener composition may include one or more compounds of Formula (I) and one or more supplemental sweetness enhancers. Without wishing to be bound by any particular theory, it is believed that addition of a supplemental sweetness enhancer allows for a reduction in the quantity of a compound of Formula (I) needed in a given composition.

Exemplary supplemental sweetness enhancers include, but are not limited to, D-psicose, erythritol, iso-rebaudioside A, rebaudioside B, rebaudioside C, rubusoside, trilobatin, phyllodulcin, brazzein, and/or mogrosides. Additional supplemental sweetness enhancers are described in U.S. Patent Application Publication Nos. 2014/0271996 and 2014/0272068, along with U.S. Pat. No. 8,877,922.

In certain embodiments, the one or more supplemental sweetness enhancers enhance the sweetness of whatever sweeteners are present in the sweetener composition, but are present in an amount below the supplemental sweetness enhancer's sweetness recognition threshold concentration.

Salts as Supplemental Sweetness Enhancers

In certain instances, the addition of one or more salts, and in particular, sodium chloride, may act as a supplemental sweetness enhancer when used in combination with a compound of Formula (I). Thus, in certain embodiments, in addition to the one or more compounds of Formula (I) and the sweetener or mixture of sweeteners, the sweetener composition may further include at least one salt. Use of a salt allows for the reduction in the quantity of the compound of Formula (I) that needs to be included in the composition, while at the same time enhancing the overall sweetness of composition in which it is included.

Suitable salts that may be included in the composition include sodium chloride or commercial salts obtained from various sources such as sea salt. The salt may be added in an amount sufficient to enhance the effectiveness of a compound of Formula (I). These salts, and in particular embodiments, sodium chloride, may be present in amounts ranging from about 200 to about 400 ppm or at about 10 weight %, about 20 weight %, about 30 weight %, about 40 weight %, or at about 50 weight % relative to the quantity of the compound of Formula (I) in a given formulation. In certain embodiments, salt allows the quantity or concentration of the compound of Formula (I) to be reduced by about 10%, about 15%, about 20%, about 25%, about 30%, about 35%, about 40%, about 45%, about 50%, or about 55% without affecting the overall sweetness of the composition.

Rare Sugar Supplemental Sweetness Enhancers

In certain embodiments, the present disclosure provides sweetener composition or a food or beverage composition comprising a combination of a compound of Formula (I), a rare sugar as a supplemental sweetness enhancer, and one or more caloric or non-caloric sweeteners. Exemplary rare sugars include D-psicose (also referred to as D-allulose), D-allose, L-ribose, D-tagatose, L-glucose, L-fucose, L-arabinose, D-turanose, D-leucrose, and mixtures thereof.

In one embodiment, a sugar-reduced beverage may be prepared using reduced quantities of sucrose or HFCS (High Fructose Corn Syrup), a compound of Formula (I), and a rare sugar such as D-psicose. Use of the compound of Formula (I) and D-psicose as the supplemental sweetness enhancer may enable a desirable degree of sugar reduction while simultaneously permitting a reduction in the concentration of the compound of Formula (I). The presence of a rare sugar may also help overall mouthfeel which may be decreased due to sugar reduction. In certain embodiments, the weight ratio of the compound of Formula (I) to D-psicose may be from about 1 to about 30.

In another embodiment, the present disclosure provides a non-caloric or low caloric beverage comprising one or more non-caloric sweeteners, a compound of Formula (I), and D-psicose as the supplemental sweetness enhancer.

In other embodiments, a compound of Formula (I) may be combined with other steviol glycosides or natural high potency sweeteners. Suitable steviol glycosides and natural high potency sweeteners include, but are not limited to, rebaudioside C, rebaudioside D, rebaudioside E, rebaudioside M, monatin and its salts, MoGro side IV, mogroside V, brazzein, thaumatin, and mixtures of any of the foregoing.

In other embodiments, a compound of Formula (I), may be used in combination with D-psicose and/or erythritol in further combination with one or more artificial non-caloric sweeteners discussed above, such as aspartame.

Sugar Alcohol Supplemental Sweetness Enhancers

In certain embodiments, the present disclosure provides sweetener compositions and food and beverage formulations comprising a compound of Formula (I), a sugar alcohol as the supplemental sweetness enhancer, and one or more sweeteners. Suitable sugar alcohols include mannitol, xylitol, sorbitol, erythritol, glycerol, threitol, arabitol, ribitol, maltitol, isomaltitol, ducitol, or lactitol, and mixture thereof.

Non-Caloric Natural Supplemental Sweetness Enhancers

In certain embodiments, this disclosure provides a sweetener composition as well as food and beverage formulations comprising one or more compounds of Formula (I), one or more non-caloric natural enhancers as the supplemental sweetness enhancer, and one or more sweeteners.

Suitable non-caloric natural enhancers include steviol glycosides. Suitable steviol glycosides, include, but are not limited to, stevioside, rebaudioside A, rebaudioside B, rebaudioside C, rebaudioside D, rebaudioside E, rebaudioside F, rebaudioside H, rebaudioside I, rebaudioside N, rebaudioside K, rebaudioside J, rebaudioside 0, rebaudioside M, rubusoside, dulcoside A, iso-steviol glycosides such as iso-rebaudioside A, and mixtures thereof. In a particular embodiment, the supplemental sweetness enhancer may be rubusoside, rebaudioside C or rebaudioside B.

In other embodiments, the non-caloric natural enhancer supplemental sweetness enhancer may be a mogrol glycoside. Suitable mogrol glycosides, include, but are not limited to, mogroside V, isomogroside, mogroside IV, siamenoside, and mixtures thereof.

Benzoic Acid Derived Supplemental Sweetness Enhancers

In certain embodiments, this disclosure provides a sweetener composition as well as food and beverage formulations comprising one or more compounds of Formula (I), benzoic acid or a benzoic acid derivative as the supplemental sweetness enhancer, and one or more sweeteners. Suitable benzoic acid derivatives include, but are not limited to, hydroxybenzoic acids such as 3-hydroxybenzoic acid, 4-hydroxybenzoic acid, 2,4-dihydroxybenzoic acid, 3,4-dihydroxybenzoic acid, 2,5-dihydroxybenzoic acid, 2,6-dihydroxybenzoic acid, 2,3,4-trihydroxybenzoic acid, 2,4,6-trihydroxybenzoic acid, 3-aminobenzoic acid, 4-aminobenzoic acid and combinations thereof.

In certain embodiments, this disclosure provides a sweetener composition as well as food and beverage formulations comprising one or more compounds of Formula (I), a FEMA GRAS enhancer or flavor, and one or more sweeteners. Suitable FEMA GRAS enhancers include, but are not limited to, FEMA GRAS enhancer 4802, FEMA GRAS enhancer 4469, FEMA GRAS flavor 4701, FEMA GRAS enhancer 4720 (rebaudioside C), FEMA GRAS flavor 4774, FEMA GRAS enhancer 4708, FEMA GRAS enhancer 4728, FEMA GRAS enhancer 4601 (rebaudioside A) and combinations thereof. In a particular embodiment, the sweetness enhancer is FEMA GRAS flavor 4701. In another particular embodiment, the sweetness enhancer is FEMA GRAS flavor 4774.

Other Supplemental Sweetness Enhancers

In certain embodiments, this disclosure provides a sweetener composition and a food or beverage formulation comprising one or more compounds of Formula (I), one or more sweeteners, and a compound selected from the group consisting of: phyllodulcin, brazzein, a dihydrochalcone, 4-amino-5-(cyclohexyloxy)-2-methylquinoline-3-carboxylic acid or a salt thereof, 4-amino-5,6-dimethylthieno[2,3-d]pyrimidine-2(1H)-one or an analog as disclosed in US 2014/0093630, the contents of which are incorporated by reference in their entirety, and a compound according to Formula (II), below, as disclosed in U.S. Pat. No. 8,877,922 and U.S. Patent Application Publication No. 2014/0094453

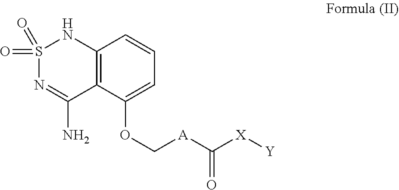

wherein A is an optionally substituted four to eight-membered azacyclic ring; X is a covalent bond or —NR¹—; R¹ is hydrogen or C₁ to C₆ alkyl; and Y is alkyl, substituted alkyl, heteroalkyl, substituted heteroalkyl, carbocyclyl, substituted carbocyclyl, heterocyclyl, substituted heterocyclyl, aryl, substituted aryl, heteroaryl, substituted heteroaryl, aralkyl, substituted aralkyl, heteroarylalkyl, or substituted heteroarylalkyl. A particular example is FEMA #4802.

Exemplary dihydrochalcones include, but are not limited to, trilobatin.

Dry Blends/Tabletop Compositions

In certain embodiments, the sweetener composition may be a dry blend of a compound of Formula (I) and a caloric sweetener. For example, the ratio of the compound of Formula (I) to caloric sweetener in the dry blend may be from about 1:400 to about 1:20 by weight, and in certain embodiments, from about 1:250 to about 1:50 by weight.

In certain embodiments, the sweetener composition may also be a dry blend of a compound of Formula (I) and non-caloric sweetener. In certain embodiments, the ratio of compound of Formula (I) to non-caloric sweetener in the dry blend may be from about 3:1 to about 1:3 by weight, and in certain embodiments, from about 1.2:1 to about 1:1.2 by weight.

In certain embodiments, the dry blend may also contain one or more salts in an amount effective to enhance the sweetening effect of the compound of Formula (I). In certain embodiments, the salt is sodium chloride and the ratio of sodium chloride to the compound of Formula (I) may be from about 2.5:1 to about 1:2.5 by weight. In other embodiments, the ratio of sodium chloride to the compound of Formula (I) may be from about 1:1 to about 1:2 by weight.

The dry blend sweetener composition may also contain one or more supplemental sweetness enhancers as discussed above. Addition of a supplemental sweetness enhancer allows for a reduction in the amount of the compound of Formula (I) in the composition.

The dry blend sweetener composition may be a granular or powdered composition such as for use as a tabletop sweetener. Alternatively, the dry blend may be added to food products for baking or as a topping or to a liquid, such as to form a beverage from a powder e.g. chocolate milk, or Instant QUAKER® Oats.

The dry blend sweetener composition may further include a binding or bulking agent, an anti-caking agent, and/or a flavor. Suitable binding or bulking agents include, but are not limited to maltodextrin; dextrose-maltodextrin blends, hydroxypropyl methyl cellulose, carboxymethyl cellulose, polyvinylpyrrolidone, and mixtures thereof. Suitable anti-caking agents include, but are not limited to alumino-silicate, magnesium carbonate, and combinations thereof.

Aqueous Compositions

In other embodiments, the sweetener composition may be included in an aqueous formulation, the formulation comprising water, a sweetener, and a compound of Formula (I). In certain embodiments, the sweetener is a caloric sweetener, a non-caloric sweetener, or a combination thereof.

In certain embodiments, the aqueous formulation may further include at least one supplemental sweetness enhancer, a salt, or a combination thereof.

Beverage Compositions

In certain embodiments, the aqueous composition may be a beverage. Any effective amount of a compound of Formula (I) may be added to the beverage compositions in order to enhance sweetness. That said, in certain embodiments, the concentration of the compound of Formula (I) in a beverage composition may range from about 40 to about 1000 ppm. In other embodiments, the concentration of the compound of Formula (I) may be at least about 100 ppm, at least about 200 ppm, at least about 300 ppm, at least about 400 ppm, at least about 500 ppm, at least about 600 ppm, at least about 700 ppm, at least about 800 ppm, at least about 900 ppm, or at least about 1000 ppm. In particular embodiments, the concentration of the compound of Formula (I) in the beverage composition may range from about 200 ppm to about 800 ppm and in still further embodiments, from about 400 ppm to about 500 ppm.

In certain embodiments, one or more caloric sweeteners may be present in a beverage composition in an amount of from about 1% to about 20% by weight of the beverage composition, such as from about 3% to about 16% by weight, or from about 5% to about 12% by weight, depending upon the desired level of sweetness in the beverage composition.

In certain embodiments, non-caloric sweeteners may be present in the beverage composition in an amount ranging from about 1 to about 600 ppm, depending upon the particular non-caloric sweetener(s) being used and the desired level of sweetness in the beverage composition.

In certain embodiments, one or more salts may be included in the beverage composition in any effective amount. In other embodiments, salt concentration may range from about 100 ppm to about 1000 ppm, or in a further embodiment from about 200 ppm to about 800 ppm. In particular embodiments, the salt may be sodium chloride. In certain embodiments, the beverage composition may be completely or substantially salt free.

The beverage composition may further comprise one or more supplemental sweetness enhancers. In certain embodiments, the supplemental sweetness enhancer may be present at a concentration below its sweetness recognition threshold concentration.

For example, and in certain embodiments, the beverage composition may contain up to about 2 weight percent each of D-psicose, erythritol, or combination thereof. In some embodiments, D-psicose and/or erythritol may be present in an amount ranging from about 0.5 to about 2.0 weight percent. Alternatively, D-psicose may be present in an amount ranging from about 0.5 to about 2.0 weight percent and erythritol may be present in an amount ranging from about 0.5 to about 1 weight percent.

In certain embodiments, the beverage composition may further comprise other ingredients such as antioxidants, food grade acids, and food grade bases. If the beverage composition is intended for use as a beverage product, other beverage components such as flavorants, colors, preservatives, carbon dioxide, buffering salts, and the like, may also be present. If the beverage composition is intended for use in food products, other food components may also be present.

In certain embodiments, the beverage composition is a beverage, i.e., a ready to drink liquid formulation. Beverages include, but are not limited to, carbonated and non-carbonated soft drinks, fountain beverages, frozen ready-to-drink beverages, coffee, tea, and other brewed beverages, dairy beverages, flavored waters, enhanced waters, juices such as fruit juice (including diluted and ready to drink concentrated juices), fruit juice-flavored drinks, sport drinks, smoothies, functionally enhanced beverages such as caffeinated energy drinks, and alcoholic products. In particular embodiments, the beverage composition may be a cola beverage.

It should be understood that beverages and other beverage products in accordance with this disclosure may have any of numerous different specific formulations or constitutions. The formulation of a beverage product in accordance with this disclosure may vary, depending upon such factors as the product's intended market segment, its desired nutritional characteristics, flavor profile, and the like. For example, further ingredients may be added to the formulation of a particular beverage embodiment. Further ingredients include, but are not limited to, one or more additional sweeteners in addition to any sweetener already present, flavorings, electrolytes, vitamins, fruit juices or other fruit products, tastants, masking agents, flavor enhancers, carbonation, or any combination of the foregoing. These may be added to any of the beverage compositions to vary the taste, mouthfeel, and/or nutritional characteristics of the beverage composition.

In certain embodiments, a beverage composition in accordance with this disclosure may comprise water, a sweetener, a compound of Formula (I), an acidulant, and a flavoring. Exemplary flavorings include, but are not limited to, cola flavoring, citrus flavoring, spice flavorings, and combinations thereof. Carbonation in the form of carbon dioxide may be added for effervescence. In certain embodiments, preservatives may be added if desired or necessary, depending upon factors including the presence of other ingredients, production technique, desired shelf life, etc. In certain embodiments, caffeine may be added to the beverage.

Certain exemplary embodiments of the beverages disclosed here are cola-flavored carbonated beverages, characteristically containing, in addition to the ingredients included in the beverage compositions disclosed herein, carbonated water, sweetener, kola nut extract and/or other flavorings, caramel coloring, phosphoric acid, and optionally other ingredients. Additional and alternative suitable ingredients will be recognized by those skilled in the art given the benefit of this disclosure.

Concentrated Aqueous Compositions

Beverages are typically not prepared in large batches. Instead, a syrup (alternatively referred to as a beverage concentrate or concentrate), water, and optionally carbon dioxide are combined at the time of use or at the time of bottling or dispensing a beverage. The syrup is a concentrated solution of many of the soluble ingredients typically included in a given beverage.

Thus, in certain embodiments, the aqueous composition may be a beverage concentrate. At least certain exemplary embodiments of the beverage concentrates contemplated may be prepared with an initial volume of water to which at least a sweetener and at least a compound of Formula (I) are added. In certain embodiments, full strength beverage compositions may be formed from the beverage concentrate by adding further volumes of water to the concentrate. In certain embodiments, a full-strength beverage may be prepared from a concentrate by combining approximately 1-part concentrate with about 3 to about 7 parts water. In certain embodiments, the full-strength beverage may be prepared by combining 1 part concentrate with 5 parts water. In certain exemplary embodiments the water added to the concentrate to form the full-strength beverages may be carbonated.

In certain embodiments, the concentration of a compound of Formula (I) in the beverage concentrate may range from about 240 to about 6000 ppm. In certain embodiments, the concentration of the compound of Formula (I) may be at least about 1200 ppm, at least about 1800 ppm, at least about 2400 ppm, or about 6000 ppm. In still further embodiments, the concentration of the compound of Formula (I) may range from about 1200 to about 1800 ppm or from about 2400 ppm to about 4800 ppm.

In certain embodiments, caloric sweeteners may be present in the concentrate at from about 6% to about 71% by weight of the beverage concentrate, such as from about 18% to about 62% by weight, or from about 30% to about 45% by weight, depending upon the desired level of sweetness for the final aqueous composition (e.g., a beverage.)

In certain embodiments, non-caloric sweeteners may be present at from about 6 to about 3600 ppm depending upon the particular non-caloric sweetener being used and the desired level of sweetness for the final aqueous composition comprising the concentrate.

In certain embodiments, one or more salts may be included in the syrup. Any effective amount of salt may be added, but in certain embodiments the salt concentration in the syrup ranges from about 600 ppm to about 6000 ppm, and in certain embodiments, from about 1200 ppm to about 2400 ppm. In certain embodiments, the syrup may be completely or substantially salt free.

In certain embodiments, the syrups may further comprise a supplemental sweetness enhancer is in an amount such that the concentration of the supplemental sweetness enhancer will be below its sweetness recognition threshold concentration in a final product.

For example, in certain embodiments, the syrup may contain up to about 18 weight percent of D-psicose, erythritol, or combination thereof. In other embodiments, D-psicose or erythritol may be present in an amount of from about 3 to about 9 weight percent. Alternatively, D-psicose may be present in an amount ranging from about 3 to about 9 weight percent and erythritol may be present in an amount of from about 3 to about 6 weight percent.

Water

Water is a basic ingredient in the aqueous compositions described herein, typically being the vehicle or primary liquid portion in which the remaining ingredients are dissolved, emulsified, suspended or dispersed. Purified water may be used in the manufacture of certain embodiments of the beverages disclosed here, and water of a standard beverage quality may be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage.

In certain embodiments, water may be present at a level of from about 20 weight percent to about 99.9 weight percent in the aqueous compositions disclosed herein. In certain beverage embodiments, the quantity of water may range from about 80 weight percent to about 99.9 weight percent of the beverage. In at least certain exemplary embodiments the water used in beverages and concentrates disclosed here is “treated water,” which refers to water that has been treated to reduce the total dissolved solids of the water prior to optional supplementation with calcium as disclosed in U.S. Pat. No. 7,052,725.

Methods of producing treated water are known to those of ordinary skill in the art and include deionization, distillation, filtration and reverse osmosis (“r-o”), among others. The terms “treated water,” “purified water,”, “demineralized water,” “distilled water,” and “r-o water” are understood to be generally synonymous in this discussion, referring to water from which substantially all mineral content has been removed, typically containing no more than about 500 ppm total dissolved solids, e.g. 250 ppm total dissolved solids.

Uses

The sweetener composition, whether a dry blend or in liquid form, may be utilized in any food or beverage product typically including a sweetener, including, but not limited to, those uses already discussed throughout this disclosure. In addition to those uses already specified, the sweetener composition described herein is also suitable for use in cooking, baking (e.g., for use in cookies, cakes, pies, brownies, breads, granola bars, etc.), for preparing sweetened toppings, such as icings, and for use in jellies, jams, preserves, Instant QUAKER Oats, and the like. It is similarly suitable for use in frozen dairy products, such as ice cream, as well as in whipped toppings. Although in certain embodiments, the sweetener composition may be dissolved in the food or beverage, in other embodiments, the sweetener composition may be present in the food or beverage as part of a suspension or emulsion.

### Natural Embodiments

Certain embodiments of the described compositions may be “natural” in that they do not contain anything artificial or synthetic (including any color additives regardless of source) that would not normally be expected to be in the food. As used herein, therefore, a “natural” composition is defined in accordance with the following guidelines: Raw materials for a natural ingredient exists or originates in nature. Biological synthesis involving fermentation and enzymes may be employed, but synthesis with chemical reagents is not utilized. Artificial colors, preservatives, and flavors are not considered natural ingredients. Ingredients may be processed or purified through certain specified techniques including at least: physical processes, fermentation, and enzymolysis. Appropriate processes and purification techniques include at least: absorption, adsorption, agglomeration, centrifugation, chopping, cooking (baking, frying, boiling, roasting), cooling, cutting, chromatography, coating, crystallization, digestion, drying (spray, freeze drying, vacuum), evaporation, distillation, electrophoresis, emulsification, encapsulation, extraction, extrusion, filtration, fermentation, grinding, infusion, maceration, microbiological (rennet, enzymes), mixing, peeling, percolation, refrigeration/freezing, squeezing, steeping, washing, heating, mixing, ion exchange, lyophilization, osmose, precipitation, salting out, sublimation, ultrasonic treatment, concentration, flocculation, homogenization, reconstitution, enzymolysis (using enzymes found in nature). Processing aids (currently defined as substances used as manufacturing aids to enhance the appeal or utility of a food component, including clarifying agents, catalysts, flocculants, filter aids, and crystallization inhibitors, etc. See 21 CFR § 170.3(o)(24)) are considered incidental additives and may be used if removed appropriately.

Additional Ingredients

In certain embodiments, the compositions disclosed herein may contain a flavor composition, for example, natural, nature identical, and/or synthetic fruit flavors, botanical flavors, other flavors, and mixtures thereof. As used here, the term “fruit flavor” refers generally to those flavors derived from the edible reproductive part of a seed plant including those plants wherein a sweet pulp is associated with the seed, e.g., tomato, cranberry, and the like, and those having a small, fleshy berry. The term berry includes true berries as well as aggregate fruits, i.e., not “true” berries, but fruit commonly accepted as such. Also included within the term “fruit flavor” are synthetically prepared flavors made to simulate fruit flavors derived from natural sources. Examples of suitable fruit or berry sources include whole berries or portions thereof, berry juice, berry juice concentrates, berry purees and blends thereof, dried berry powders, dried berry juice powders, and the like.

Exemplary fruit flavors include the citrus flavors, e.g., orange, lemon, lime grapefruit, tangerine, mandarin orange, tangelo, and pomelo, apple, grape, cherry, and pineapple flavors. In certain embodiments concentrates and beverages comprise a fruit flavor component, e.g., a juice concentrate or juice. As used here, the term “botanical flavor” refers to flavors derived from parts of a plant other than the fruit. As such, botanical flavors may include those flavors derived from essential oils and extracts of nuts, bark, roots, and leaves. Also included within the term “botanical flavor” are synthetically prepared flavors made to simulate botanical flavors derived from natural sources. Examples of such flavors include cola flavors, tea flavors, and mixtures thereof. The flavor component may further comprise a blend of several of the above-mentioned flavors. In certain exemplary embodiments of the beverage concentrates and beverages a cola flavor component is used or a tea flavor component. The particular amount of the flavor component useful for imparting flavor characteristics to the beverages of the present disclosure will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

Juices suitable for use in at least certain exemplary embodiments of the beverage products disclosed here include, e.g., fruit, vegetable and berry juices. Juices may be employed in the present compositions in the form of a concentrate, puree, single-strength juice, or other suitable forms. The term “juice” as used here includes single-strength fruit, berry, or vegetable juice, as well as concentrates, purees, milks, and other forms. Multiple different fruit, vegetable and/or berry juices may be combined, optionally along with other flavorings, to generate a concentrate, beverage, or solid food having a desired flavor. Examples of suitable juice sources include plum, prune, date, currant, fig, grape, raisin, cranberry, pineapple, peach, banana, apple, pear, guava, apricot, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, litchi, lemon, orange, lime, tangerine, mandarin, melon, watermelon, and grapefruit. Numerous additional and alternative juices suitable for use in at least certain exemplary embodiments will be apparent to those skilled in the art given the benefit of this disclosure. In the compositions of the present disclosure employing juice, juice may be used, for example, at a level of at least about 0.2 weight percent of the composition. In certain embodiments juice may be employed at a level of from about 0.2 weight percent to about 40 weight percent. In further embodiments, juice may be used, if at all, in an amount ranging from about 1 to about 20 weight percent.

Juices that are lighter in color may be included in the formulation of certain exemplary embodiments to adjust the flavor and/or increase the juice content of the beverage without darkening the beverage color. Examples of such juices include apple, pear, pineapple, peach, lemon, lime, orange, apricot, grapefruit, tangerine, rhubarb, cassis, quince, passion fruit, papaya, mango, guava, litchi, kiwi, mandarin, coconut, and banana. De-flavored and de-colored juices may be employed if desired.

Other flavorings suitable for use in at least certain exemplary embodiments of the food and beverage products disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings may be in the form of an extract, oleoresin, juice concentrate, bottler's base, or other forms known in the art. In at least certain exemplary embodiments, such spice or other flavors complement that of a juice or juice combination.

The one or more flavorings may be used in the form of an emulsion. A flavoring emulsion may be prepared by mixing some or all of the flavorings together, optionally together with other ingredients of the food or beverage, and an emulsifying agent. The emulsifying agent may be added with or after the flavorings mixed together. In certain exemplary embodiments the emulsifying agent is water-soluble. Exemplary suitable emulsifying agents include gum acacia, modified starch, carboxymethylcellulose, gum tragacanth, gum ghetto and other suitable gums. Additional suitable emulsifying agents will be apparent to those skilled in the art of beverage formulations, given the benefit of this disclosure. The emulsifier in exemplary embodiments comprises greater than about 3% of the mixture of flavorings and emulsifier. In certain exemplary embodiments the emulsifier is from about 5% to about 30% of the mixture.

Carbon dioxide may be used to provide effervescence to certain exemplary embodiments of the beverages disclosed here. Any of the techniques and carbonating equipment known in the art for carbonating beverages may be employed. Carbon dioxide may enhance beverage taste and appearance and may aid in safeguarding the beverage purity by inhibiting and/or destroying objectionable bacteria. In certain embodiments, for example, the beverage may have a CO2 level up to about 4.0 volumes carbon dioxide. Other embodiments may have, for example, from about 0.5 to about 5.0 volumes of carbon dioxide. As used herein, one volume of carbon dioxide refers to the amount of carbon dioxide absorbed by a given quantity of a given liquid, such as water, at 60° F. (16° C.) and one atmospheric pressure. A volume of gas occupies the same space as does the liquid by which it is dissolved. The carbon dioxide content may be selected by those skilled in the art based on the desired level of effervescence and the impact of the carbon dioxide on the taste or mouthfeel of the beverage.

In certain embodiments, caffeine may be added to any of the disclosed foods, beverages, or syrups described herein. The amount of caffeine added may be determined by the desired properties of a given food, beverage, or syrup, and any applicable regulatory provisions of the country where the food, beverage, or syrup is marketed. In certain embodiments caffeine may be included in an amount sufficient to provide a final beverage product having less than about 0.02 weight percent caffeine. The caffeine must be of purity acceptable for use in foods and beverages. The caffeine may be natural or synthetic in origin.

The food and beverage products disclosed here may contain additional ingredients, including, generally, any of those typically found in food and beverage formulations. Examples of such additional ingredients include, but are not limited to, caramel and other coloring agents or dyes, foaming or antifoaming agents, gums, emulsifiers, tea solids, cloud components, and mineral and non-mineral nutritional supplements. Examples of non-mineral nutritional supplement ingredients are known to those of ordinary skill in the art and include, for example, antioxidants and vitamins, including Vitamins A, D, E (tocopherol), C (ascorbic acid), B (thiamine), B2 (riboflavin), B6, B12, K, niacin, folic acid, biotin, and combinations thereof. The optional non-mineral nutritional supplements are typically present in amounts generally accepted under good manufacturing practices. Exemplary amounts may be between about 1% and about 100% Recommended Daily Value (RDV), where such RDVs are established. In certain exemplary embodiments the non-mineral nutritional supplement ingredient(s) may be present in an amount of from about 5% to about 20% RDV, where established.

Preservatives may be used in at least certain embodiments of the food products and beverages disclosed here. That is, at least certain exemplary embodiments may contain an optional dissolved preservative system. Solutions with a pH below 4 and especially those below 3 typically are “micro-stable,” i.e., they resist growth of microorganisms, and so are suitable for longer term storage prior to consumption without the need for further preservatives. However, an additional preservative system may be used if desired. If a preservative system is used, it may be added to the product at any suitable time during production, e.g., in some cases prior to the addition of the sweetener composition. As used here, the terms “preservation system” or “preservatives” include all suitable preservatives approved for use in food and beverage compositions, including, without limitation, such known chemical preservatives as benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), and mixtures thereof, and antioxidants such as ascorbic acid, EDTA, BHA, BHT, TBHQ, dehydroacetic acid, dimethyldicarbonate, ethoxyquin, heptylparaben, and combinations thereof. Preservatives may be used in amounts not exceeding mandated maximum levels under applicable laws and regulations.

In the case of beverages in particular, the level of preservative used may be adjusted according to the planned final product pH and/or the microbiological spoilage potential of the particular beverage formulation. The maximum level employed typically is about 0.05 weight percent of the beverage. It will be within the ability of those skilled in the art, given the benefit of this disclosure, to select a suitable preservative or combination of preservatives for beverages according to this disclosure.

Other methods of preservation suitable for at least certain exemplary embodiments of the products disclosed here include, e.g., aseptic packaging and/or heat treatment or thermal processing steps, such as hot filling and tunnel pasteurization. Such steps may be used to reduce yeast, mold and microbial growth in the beverage products. For example, U.S. Pat. No. 4,830,862 discloses the use of pasteurization in the production of fruit juice beverages as well as the use of suitable preservatives in carbonated beverages. U.S. Pat. No. 4,925,686 discloses a heat-pasteurized freezable fruit juice composition which contains sodium benzoate and potassium sorbate. Typically, heat treatment includes hot fill methods typically using high temperatures for a short time, e.g., about 190° F. for 10 seconds, tunnel pasteurization methods typically using lower temperatures for a longer time, e.g., about 160° F. for 10-15 minutes, and retort methods typically using, e.g., about 250° F. for 3-5 minutes at elevated pressure, i.e., at pressure above 1 atmosphere.

Suitable antioxidants may be selected from the group consisting of rutin, quercetin, flavonones, flavones, dihydroflavonols, flavonols, flavandiols, leucoanthocyanidins, flavonol glycosides, flavonone glycosides, isoflavonoids, and neoflavonoids. In particular, the flavonoids may be, but not limited to, quercetin, eriocitrin, neoeriocitrin, narirutin, naringin, hesperidin, hesperetin, neohesperidin, neoponcirin, poncirin, rutin, isorhoifolin, rhoifolin, diosmin, neodiosmin, sinensetin, nobiletin, tangeritin, catechin, catechin gallate, epigallocatechin, epigallocatechin gallate, oolong tea polymerized polyphenol, anthocyanin, heptamethoxyflavone, daidzin, daidzein, biochaminn A, prunetin, genistin, glycitein, glycitin, genistein, 6,7,4′ trihydroxy isoflavone, morin, apigenin, vitexin, balcalein, apiin, cupressuflavone, datiscetin, diosmetin, fisetin, galangin, gossypetin, geraldol, hinokiflavone, primuletin, pratol, luteolin, myricetin, orientin, robinetin, quercetagetin, and hydroxy-4-flavone.

Suitable food grade acids are water soluble organic acids and their salts and include, for example, phosphoric acid, sorbic acid, ascorbic acid, benzoic acid, citric acid, tartaric acid, propionic acid, butyric acid, acetic acid, succinic acid, glutaric acid, maleic acid, malic acid, valeric acid, caproic acid, malonic acid, aconitic acid, potassium sorbate, sodium benzoate, sodium citrate, amino acids, and combinations of any of them. Such acids are suitable for adjusting the pH of the beverage.

Suitable food grade bases are sodium hydroxide, potassium hydroxide, and calcium hydroxide. Such bases also are suitable for adjusting the pH of a beverage.

The disclosure will be more fully understood upon consideration of the following non-limiting Examples. It should be understood that these examples, while indicating preferred embodiments of the subject technology, are given by way of illustration only. From the above discussion and these examples, one skilled in the art can ascertain the essential characteristics of the subject technology, and without departing from the spirit and scope thereof, can make various changes and modifications of the subject technology to adapt it to various uses and conditions.

### EXAMPLES

### Sweetness Enhancing Compounds.

Table 1 below provides the chemical name, formula, molar mass, and chemical structure of the present sweetness enhancing compounds.

TABLE 1

| Compound | | | Molar | |
|---|---|---|---|---|
| No. | Chemical Name | Formula | Mass | Chemical Structure |
| 1 | 4-(3,4-dihydroxyphenyl)-5- hydroxy-7-methylchroman- 2-one | C₁₆H₁₄O₅ | 286.2836 g/mol | 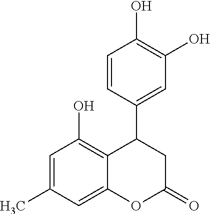 [SMILES: Cc1cc(O)c2c(c1)OC(=O)CC2c1ccc(O)c(O)c1] |
| 2 | 6-hydroxy-4-(4-hydroxy-3- methoxyphenyl)-5- methylchroman-2-one | C₁₇H₁₆O₅ | 300.3104 g/mol | 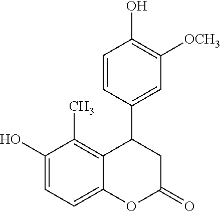 [SMILES: COc1cc(C2CC(=O)Oc3ccc(O)c(C)c32)ccc1O] |
| 3 | 5-hydroxy-4-(4-hydroxy-3- methoxyphenyl)chroman- 2-one | C₁₆H₁₄O₅ | 286.2836 g/mol | 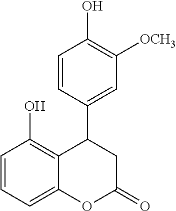 [SMILES: COc1cc(C2CC(=O)Oc3cccc(O)c32)ccc1O] |

### Example 1—Synthesis of Compound (1)

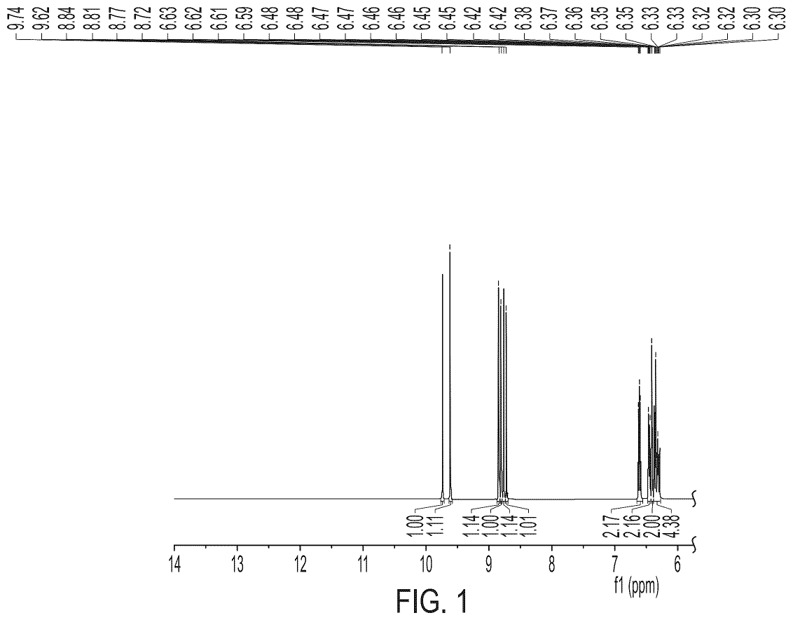

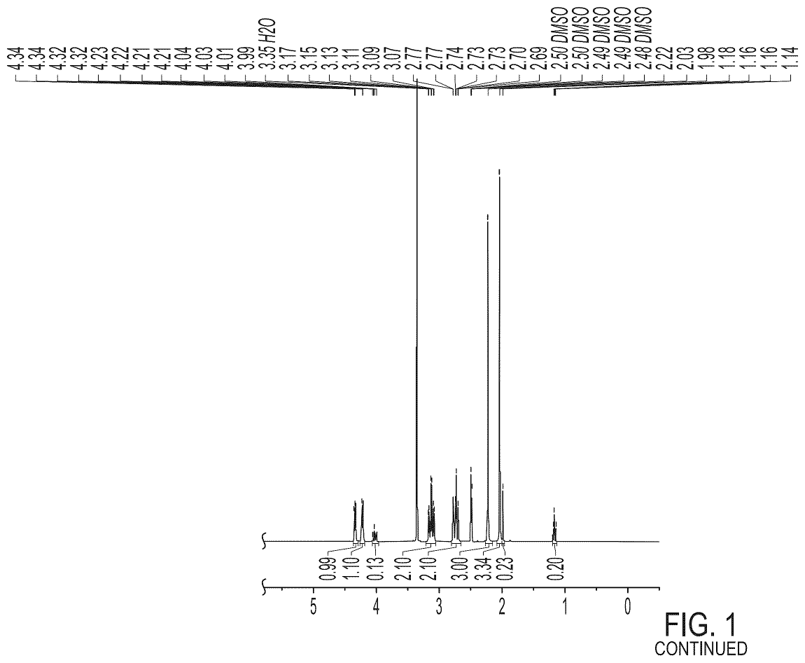

Caffeic acid (9.28 g, 51.50 mmol), orcinol monohydride (9.05 g, 63.58 mmol), L-tartaric acid (20.00 g) and L-malic acid (20.00 g) were mixed, heated and kept at 155° C. to 165° C. for one hour. After being cooled to 40° C., the mixture was mixed with ethyl acetate (200 ml) and brine (200 ml), stirred overnight and separated. The organic layer was washed with brine, dried over anhydrous magnesium sulfate, filtered and concentrated in reduced pressure to give a crude product. The crude product was purified by column chromatography with hexane and ethyl acetate (from 100/0 to 65/35) and recrystallized from hexane and ethyl acetate (1:1) to give 2.01 g of white solid as the pure product. Molecular Formular: C₁₆H₁₄O₅, Exact Mass: 286.08; (−)m/z:285. FIG. 1 shows the NMR spectrum of the obtained Compound (1).

### Example 2—Synthesis of Compound (2)

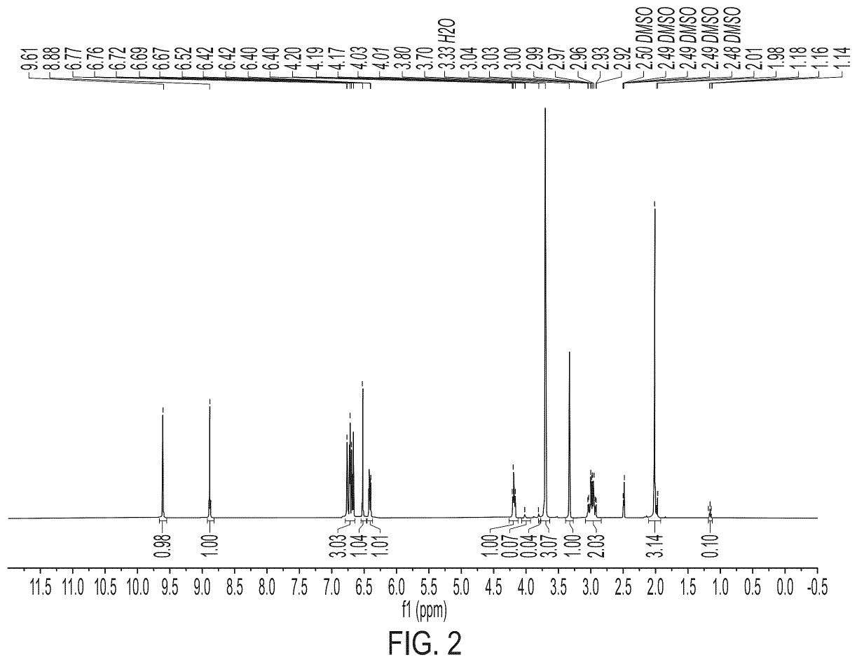

Ferulic acid (98.90 g, 45.84 mmol), 4-methylresorcinol (7.00 g, 56.39 mmol), L-tartaric acid (20.00 g) and L-malic acid (20.00 g) were mixed, heated and kept at 155° C. to 165° C. for one hour. After being cooled to 40° C., the mixture was mixed with ethyl acetate (200 ml) and brine (200 ml), stirred overnight and separated. The organic layer was washed with brine, dried over anhydrous magnesium sulfate, filtered and concentrated in reduced pressure to give a crude product. The crude product was purified by column chromatography with hexane and ethyl acetate (from 100/0 to 65/35) and recrystallized from hexane and ethyl acetate (1:1) to give 1.25 g of a white solid as the pure product. Molecular Formula: C₁₇H₁₆O₅, Exact Mass:300.10; (−)m/z:299. FIG. 2 shows the NMR spectrum of the obtained Compound (2).

### Example 3—Synthesis of Compound (3)

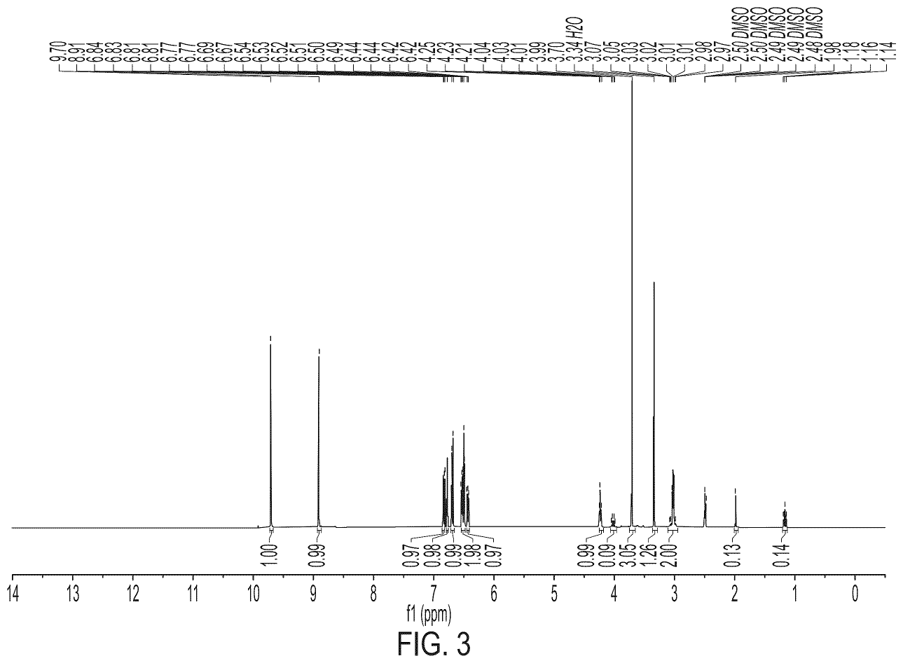

Ferulic acid (10.00 g, 51.50 mmol), resorcinol (7.00 g, 63.58 mmol), L-tartaric acid (20.00 g) and L-malic acid (20.00 g) were mixed, heated and kept at 155° C. to 165° C. for one hour. After being cooled to 40° C., the mixture was mixed with ethyl acetate (200 ml) and brine (200 ml), stirred overnight and separated. The organic layer was washed with brine, dried over anhydrous magnesium sulfate, filtered and concentrated in reduced pressure to give a crude product. The crude product was purified by column chromatography with hexane and ethyl acetate (from 100/0 to 65/35) and recrystallized from hexane and ethyl acetate (1:1) to give 0.91 g of a white solid as the pure product. Molecular formula: C₁₆H₁₄O₅; Exact Mass:286.08; (−)m/z:285. FIG. 3 shows the NMR spectrum of the obtained Compound (3).

### Example 4—Inherent Sweetness of Compounds (1), (2), and (3)

The inherent sweetness of Compounds (1), (2), and (3) as perceived by human subjects was evaluated using a two-alternative forced choice “sip and spit” method (2AFC). The 2AFC test used for compound evaluation was a double-blinded and randomized test where taste panelists (n=30) evaluated a pair of sweetener solutions at a time—one sample is a 1.5% sucrose control, while the other is an aqueous solution containing a test compound at the indicated concentration. Panelists were instructed not to eat or drink (except water) for at least 1 hour before the test. During the test panelists were instructed to sip each sample, swirl it around their mouth and then expectorate. After tasting each sample in the pair, panelists were instructed to record whether they perceived the sample as comparable in sweetness to the control. Panelists cleansed their palates by rinsing with water, eating a cracker and waiting for an interval of about 5 minutes. All samples were tested at ambient temperatures. The results of the 2AFC analysis are presented in Table 1 below.

TABLE 1

| | Concen- | | |
|---|---|---|---|
| | tration | | |
| Sample | (ppm) | Control | Result |
| Compound (1) | 20 | 1.5% | 1 of 30 panelists chose Sample as |
| | | sucrose | comparable in sweetness to Control. |
| Compound (1) | 50 | 1.5% | 2 of 30 panelists chose Sample as |
| | | sucrose | comparable in sweetness to Control. |
| Compound (1) | 80 | 1.5% | 2 of 30 panelists chose Sample as |
| | | sucrose | comparable in sweetness to Control. |
| Compound (2) | 20 | 1.5% | 1 of 30 panelists chose Sample as |
| | | sucrose | comparable in sweetness to Control. |
| Compound (2) | 50 | 1.5% | 1 of 30 panelists chose Sample as |
| | | sucrose | comparable in sweetness to Control. |
| Compound (2) | 80 | 1.5% | 1 of 30 panelists chose Sample as |
| | | sucrose | comparable in sweetness to Control. |
| Compound (3) | 20 | 1.5% | 2 of 30 panelists chose Sample as |
| | | sucrose | comparable in sweetness to Control. |
| Compound (3) | 50 | 1.5% | 2 of 30 panelists chose Sample as |
| | | sucrose | comparable in sweetness to Control. |
| Compound (3) | 80 | 1.5% | 1 of 30 panelists chose Sample as |
| | | sucrose | comparable in sweetness to Control. |

### Example 5—Increase in Perceived Sweetness with Addition of Compounds (1), (2), and (3)

The sweetness enhancing effect of Compounds (1), (2), and (3) when used with certain sweeteners (specifically, sucrose or rebaudioside M) was evaluated using a two-alternative forced choice “sip and spit” method (2AFC). The 2AFC test used for compound evaluation was a double-blinded and randomized test where taste panelists (n=30) evaluated a pair of sweetener solutions at a time—one sample contains aqueous sweetener solution plus compound (test sample), while the other contains the aqueous sweetener solution without compound (control). Each test sample was compared against a positive control. For example, if the test sample contained 5% sucrose solution with Compound (1), the positive control contained a 5% sucrose solution (i.e., without Compound (1)).

Panelists were instructed not to eat or drink (except water) for at least 1 hour before the test. During the test panelists were instructed to sip each sample, swirl it around their mouth and then expectorate. After tasting each sample in the pair, panelists were instructed to record the sample that is “sweeter” in taste. Panelists cleansed their palates by rinsing with water, eating a cracker and waiting for an interval of about 5 minutes. All samples were tested at ambient temperatures. The results of the 2AFC analysis are presented in Table 2 below.

TABLE 2

| | Concen- | | |
|---|---|---|---|
| | tration | | |
| Test Sample | (ppm) | Control | Result |
| Compound (1) | 60 | 5% sucrose | 21 of 30 panelists |
| | | solution | chose Test Sample as |
| | | | sweeter than Control. |
| Compound (1) | 20 | 100 ppm | 29 of 30 panelists |
| | | Reb M | chose Sample as |
| | | solution | sweeter than Control. |
| Compound (2) | 40 | 5% sucrose | 29 of 30 panelists |
| | | solution | chose Sample as |
| | | | sweeter than Control. |
| Compound (2) | 20 | 100 ppm | 30 of 30 panelists |
| | | Reb M | chose Sample as |
| | | solution | sweeter than Control. |
| Compound (3) | 20 | 5% sucrose | 28 of 30 panelists |
| | | solution | chose Sample as |
| | | | sweeter than Control. |
| Compound (3) | 40 | 100 ppm | 20 of 30 panelists |
| | | Reb M | chose Sample as |
| | | solution | sweeter than Control. |

What is claimed is:

1. A composition comprising one or more sweeteners and a compound of Formula (I) and/or a physiologically acceptable salt, enantiomer, or solvate thereof: 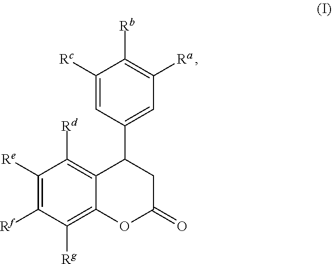
wherein:
each of R^{a}, R^{b}, and R^{c} independently are H, OH, or a C₁₋₅ alkoxy group, provided that at least two of R^{a}, R^{b}, and R^{c} independently are OH or a C₁₋₅ alkoxy group;
each of R^{d}, R^{e}, R^{f}, and R^{g} independently are H, OH, or a C₁₋₅ alkyl group, provided that R^{d} is OH or a C₁₋₅ alkyl group; and
wherein:
R^{f} is H when (i) R^{a} is OCH₃ and R^{b} is OH or (ii) R^{a} is OH and R^{b} is OCH₃.

2. The composition of claim 1, wherein R^{b} is OH and R^{a} is either OH or OCH₃.

3. The composition of claim 1 or 2, wherein R^{d} is either OH or CH₃.

4. The composition of claim 1 comprising at least one of Compound (1), Compound (2), Compound (3), and/or a physiologically acceptable salt, enantiomer, or solvate thereof, wherein Compound (1) has the structure: 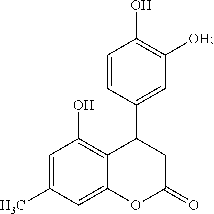 [SMILES: Cc1cc(O)c2c(c1)OC(=O)CC2c1ccc(O)c(O)c1]
Compound (2) has the structure: 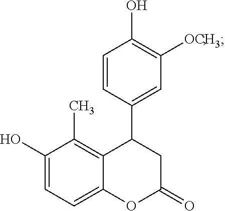 [SMILES: COc1cc(C2CC(=O)Oc3ccc(O)c(C)c32)ccc1O]
and
Compound (3) has the structure:

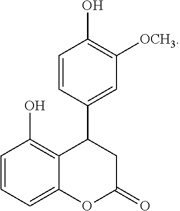 [SMILES: COc1cc(C2CC(=O)Oc3cccc(O)c32)ccc1O]

5. The composition of any one of claims 1-4, wherein said composition is an orally consumable composition and the compound of formula (I) is capable of enhancing the sweet taste of at least one of said sweeteners and/or the overall sweet taste of the composition.

6. The composition of claim 5, wherein the one or more sweeteners are selected from the group consisting of a caloric sweetener, a non-caloric sweetener, an artificial sweetener, a natural high-potency sweetener, a sugar alcohol, a rare sugar, and a combination of any of the foregoing sweeteners.

7. The composition of claim 6, wherein the caloric sweetener is selected from crystalline or liquid sucrose, fructose, glucose, dextrose, maltose, trehalose, fructo-oligosaccharides, glucose-fructose syrup; high fructose corn syrup, invert sugar, maple syrup, maple sugar, honey, brown sugar molasses, yacon syrup, cane molasses, sorghum syrup, and mixtures thereof.

8. The composition of claim 6, wherein the artificial sweetener is saccharin, cyclamate, aspartame, neotame, advantame, acesulfame potassium, sucralose, or mixtures thereof.

9. The composition of claim 6, wherein the natural high-potency sweetener is a steviol glycoside, a glycosylated steviol glycoside, Luo Han Guo fruit extract, glycyrrhizin, or thaumatin.

10. The composition of claim 6, wherein the high-potency sweetener is rebaudioside A, rebaudioside B, rebaudioside C (dulcoside B), rebaudioside D, rebaudioside E, rebaudioside F, rebaudioside I, rebaudioside N, rebaudioside M, dulcoside A, rubusoside, stevioside, mogroside, or a mixture of any of the foregoing.

11. The composition of claim 6, wherein the sugar alcohol is mannitol, xylitol, sorbitol, erythritol, glycerol, threitol, arabitol, ribitol, maltitol, isomaltitol, ducitol, or lactitol.

12. The composition of claim 6, wherein the rare sugar is D-allose, D-allulose, L-ribose, D-tagatose, L-glucose, L-fucose, L-arabinose, D-turanose, D-leucrose, or mixtures thereof.

13. The composition of any one of claims 1-12, wherein the composition is a food product, a beverage, an oral care product, or a pharmaceutical composition.

14. A method of enhancing the sweet taste of a composition comprising one or more sweeteners, the method comprising adding to said composition an effective amount of a compound of formula (I) and/or a physiologically acceptable salt, enantiomer, or solvate thereof: 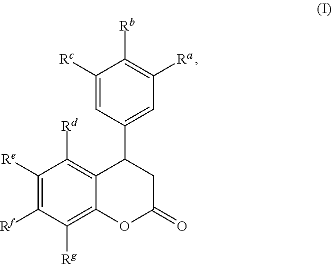
wherein:
each of R^{a}, R^{b}, and R^{c} independently are —H, —OH, or a C₁₋₅ alkoxy group, provided that at least two of R^{a}, R^{b}, and R^{c} independently are OH or a C₁₋₅ alkoxy group;
each of R^{d}, R^{e}, R^{f}, and R^{g} independently are H, OH, or a C₁₋₅ alkyl group, provided that R^{d} is OH or a C₁₋₅ alkyl group; and
wherein:
R^{f} is H when (i) R^{a} is OCH₃ and R^{b} is OH or (ii) R^{a} is OH and R^{b} is OCH₃;
such that the perception of sweetness intensity of at least one of said sweeteners is enhanced.

15. The method of claim 14, wherein R^{b} is OH and R^{a} is either OH or OCH₃.

16. The method of claim 14 or 15, wherein R^{d} is either OH or CH₃.

17. The method of claim 14, wherein the compound of formula (I) is Compound (1), Compound (2), or Compound (3), wherein:
Compound (1) has the structure: 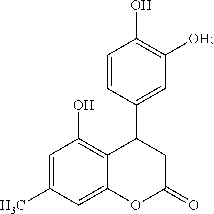 [SMILES: Cc1cc(O)c2c(c1)OC(=O)CC2c1ccc(O)c(O)c1]
Compound (2) has the structure: 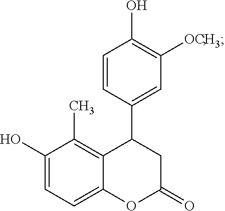 [SMILES: COc1cc(C2CC(=O)Oc3ccc(O)c(C)c32)ccc1O]
and
Compound (3) has the structure:

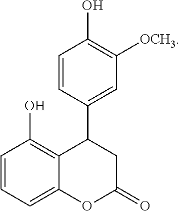 [SMILES: COc1cc(C2CC(=O)Oc3cccc(O)c32)ccc1O]

18. The method of any one of claims 14-17, wherein said composition is an orally consumable composition.

19. The method of claim 18, wherein the composition is a food product, a beverage, an oral care product, or a pharmaceutical composition.

20. The method of claim 14, wherein the one or more sweeteners are selected from the group consisting of a caloric sweetener, a non-caloric sweetener, an artificial sweetener, a natural high-potency sweetener, a sugar alcohol, a rare sugar, and a combination of any of the foregoing sweeteners.

21. The method of claim 14, wherein the caloric sweetener is the caloric sweetener is selected from crystalline or liquid sucrose, fructose, glucose, dextrose, maltose, trehalose, fructo-oligosaccharides, glucose-fructose syrup; high fructose corn syrup, invert sugar, maple syrup, maple sugar, honey, brown sugar molasses, yacon syrup, cane molasses, sorghum syrup, and mixtures thereof.

22. The method of claim 14, wherein the artificial sweetener is saccharin, cyclamate, aspartame, neotame, advantame, acesulfame potassium, sucralose, or mixtures thereof.

23. The method of claim 14, wherein the natural high-potency sweetener is a steviol glycoside, a glycosylated steviol glycoside, Luo Han Guo fruit extract, glycyrrhizin, or thaumatin.

24. The method of claim 14, wherein the high-potency sweetener is rebaudioside A, rebaudioside B, rebaudioside C (dulcoside B), rebaudioside D, rebaudioside E, rebaudioside F, rebaudioside I, rebaudioside N, rebaudioside M, dulcoside A, rubusoside, stevioside, mogroside, or a mixture of any of the foregoing.

25. The method of claim 14, wherein the sugar alcohol is mannitol, xylitol, sorbitol, erythritol, glycerol, threitol, arabitol, ribitol, maltitol, isomaltitol, ducitol, or lactitol.

26. The method of claim 14, wherein the rare sugar is D-allose, D-allulose, L-ribose, D-tagatose, L-glucose, L-fucose, L-arabinose, D-turanose, D-leucrose, or mixtures thereof.
